(19) United States
(12) Patent Application Publication
(10) Pub. No.: US 2023/0152782 A1
(43) Pub. Date: May 18, 2023

(54) CONTROLLER

(71) Applicant: FANUC CORPORATION, Yamanashi (JP)

(72) Inventors: Satoshi KIMURA, Yamanashi (JP); Akira KANEMARU, Yamanashi (JP)

(21) Appl. No.: 17/996,788

(22) PCT Filed: Apr. 21, 2021
(86) PCT No.: PCT/JP2021/016157

§ 371 Date: Oct. 21, 2022

(30) Foreign Application Priority Data
Apr. 24, 2020 (JP) 2020-077565

(51) Int. Cl. G05B 19/4155

(52) U.S. Cl. CPC G05B 19/4155; G05B 2219/42192

(57) ABSTRACT

By controlling an operation of one reference axis using a control program, a controller operates another axis in synchronization with the reference axis. The controller generates shift information indicating an operation timing of another axis with respect to the reference axis, and determines a timing of outputting a movement amount related to each of the plurality of axes according to the generated shift information. Then, the controller outputs a movement amount of an axis, for which it is determined that it is a timing to output the movement amount, and buffers a movement amount of an axis, for which it is determined that it is not a timing to output the movement amount.

### TECHNICAL FIELD

The present invention relates to a controller, and particularly relates to a controller capable of designating an operation timing of an industrial machine equipped with axes which have synchronous relationship therebetween.

### BACKGROUND ART

The number of industrial machines provided with a slave axis driven in synchronization with a master axis has been increasing (for example, Patent Document 1, etc.). For synchronous control of such industrial machines, there is a method of distributing the movement amount calculated from the movement amount of the master axis and a synchronization ratio to the slave axis.

FIG. 8 is a block diagram illustrating a configuration of a conventional numerical controller 1 that performs synchronous control. A program input unit 110 reads a control program 200 for a master axis from the outside and stores the control program 200 in a RAM or a non-volatile memory (not illustrated). The program analysis unit 120 analyzes the control program 200 acquired by the program input unit 110. A movement amount calculation unit 130 calculates the movement amount of the master axis based on the control program 200 analyzed by the program analysis unit 120. The movement amount distribution unit 140 calculates the distribution movement amount (distribution data) obtained by distributing the movement amount of the master axis calculated by the movement amount calculation unit 130 to each control cycle of the master axis. A synchronous control unit 150 calculates the distribution movement amount (distribution data) of a slave axis from the synchronization ratio and the distribution movement amount calculated by the movement amount distribution unit 140. A movement amount output unit 160 outputs the distribution movement amount of the master axis calculated by the synchronous control unit 150 and the distribution movement amount of the slave axis to an axis control interface 170 provided for each of the master axis and the slave axis.

As described above, without separately creating a control program 200 for the slave axis, the slave axis may be operated synchronously with the master axis by using the control program for the master axis. In this case, since the distribution movement amount of the slave axis is calculated from the distribution movement amount of the master axis and the synchronization ratio, the slave axis and the master axis start operation at the same timing.

### CITATION LIST

### Patent Literature

Patent Document 1: JP 2005-322076 A

### SUMMARY OF INVENTION

### Technical Problem

There is a case where it is desired to adjust an operation start timing of a master axis and a slave axis, having synchronous relationship therebetween, as a machine configuration of an industrial machine or an operation request.

For example, FIG. 9 illustrates an industrial machine that moves a machining table 81 on two axes.

A ball screw 82m controlled by a master axis, which is longer than a ball screw 82s controlled by a slave axis, is used. The inertia of the ball screw 82m controlled by the master axis becomes larger than the inertia of the ball screw 82s controlled by the slave axis due to a difference in length. When the master axis and the slave axis are driven at the same time, the ball screw 82m controlled by the master axis starts rotating later than the ball screw 82s controlled by the slave axis.

Therefore, in order to move the machining table by synchronizing the ball screw 82m controlled by the master axis with the ball screw 82s controlled by the slave axis, it is necessary to delay a drive timing of the slave axis with respect to the master axis in consideration of a difference in inertia caused by the difference in length between the ball screws.

Note that in FIG. 9, reference symbol 83m is a servomotor of the master axis, and reference symbol 83s is a servomotor of the slave axis.

In addition, FIG. 10 illustrates an example of an industrial machine that rotates a plurality of axes (rollers), which is used when winding a metal wire around a mandrel using a winding machine or when sending cloth or a chloride film in line manufacturing. In such an industrial machine, when all the axes are driven at the same time, tension is applied to an object (chloride film in FIG. 10) wound up or transferred between the axes, so that damage may occur, such as the object spreading and becoming uneven in thickness and length, or the object breaking.

In order to avoid this problem, it is necessary to assign a slight slack to the object by driving the axes in order from a source to a destination. In the example of FIG. 10, the timing may be delayed so that driving starts from the master axis on the source side and at a slave axis #1 and a slave axis #2 on the destination side in this order.

Note that in FIG. 10, reference symbol 84m denotes a roller of the master axis, reference symbol 84s1 denotes a roller of the slave axis #1, and reference symbol 84s2 denotes a roller of the slave axis #2. Further, reference symbol 85m denotes a servomotor of the master axis, reference symbol 85s1 denotes a servomotor of the slave axis #1, reference symbol 85s2 denotes a servomotor of the slave axis #2, and reference symbol 86 denotes a chloride film.

Further, FIG. 11 illustrates an example of an industrial machine such as a work loader or a belt conveyor that moves an object by moving a driving unit up and down with a time lag.

In an industrial machine in which such line control is performed, it is necessary to drive the slave axis #1 to the slave axis #4 by sequentially shifting phases in conjunction with drive of the master axis, and thus it is necessary to delay a drive timing of the slave axis with respect to the master axis.

Note that in FIG. 11, reference symbol 87m denotes a driving unit of the master axis, and reference symbols 87s1 to 87s4 denote driving units of the slave axis #1 to the slave axis #4. Further, reference symbol 88m denotes a servomotor of the master axis, and reference symbols 88s1 to 88s4 denote servomotors of the slave axis #1 to the slave axis #4.

In this way, when an operation required by the industrial machines illustrated in FIGS. 9 to 11 is performed, as illustrated in FIG. 12, it is necessary to perform multi-system control, execute a control program for each axis, and perform waiting and start timing adjustment between systems to synchronize operations of axes. Therefore, in addition to the control program 200 for the master axis, control programs 202 and 204 for respective slave axes need be created, which causes a problem in that burden on a user is large.

Therefore, there is a demand for technology capable of operating the master axis and the slave axis using one control program and adjusting an operation start timing of each axis.

### Solution to Problem

A controller in an aspect of the disclosure is a controller for controlling a plurality of axes based on a control program for controlling an operation of one shift reference axis among the plurality of axes, the controller including a synchronous control unit configured to calculate a distribution movement amount of another axis in synchronization with the shift reference axis based on a distribution movement amount of the shift reference axis, a shift information generation unit configured to generate shift information including a shift element indicating an operation timing of another axis with respect to the shift reference axis, a movement amount output determination unit configured to determine a timing of outputting a movement amount related to each of the plurality of axes according to the shift information, and a movement amount storage unit configured to output a movement amount of an axis when the movement amount output determination unit determines that it is a timing to output the movement amount, and to buffer a movement amount of an axis when the movement amount output determination unit determines that it is not a timing to output the movement amount.

### Advantageous Effects of Invention

According to an aspect of the invention, it is unnecessary to create a control program for each axis, so that burden on an operator may be reduced. In addition, since it is unnecessary to hold and process a plurality of control programs by a controller, efficient control with less resources may be achieved.

### BRIEF DESCRIPTION OF DRAWINGS

FIG. 1 is a schematic hardware configuration diagram illustrating a main part of a controller according to a first embodiment;

FIG. 2 is a schematic block diagram illustrating a function provided by the controller according to the first embodiment;

FIG. 3 is a diagram illustrating an example of shift information generated by a shift information generation unit;

FIG. 4 is a diagram for describing an operation of a movement amount output determination unit;

FIG. 5 is a diagram (1) for describing an operation of a movement amount storage unit;

FIG. 6 is a diagram (2) for describing the operation of the movement amount storage unit;

FIG. 7 is a diagram illustrating an example in which a plurality of axes is operated by shifting timings by one control program;

FIG. 8 is a schematic block diagram illustrating a configuration of a controller that performs synchronous control according to a related art;

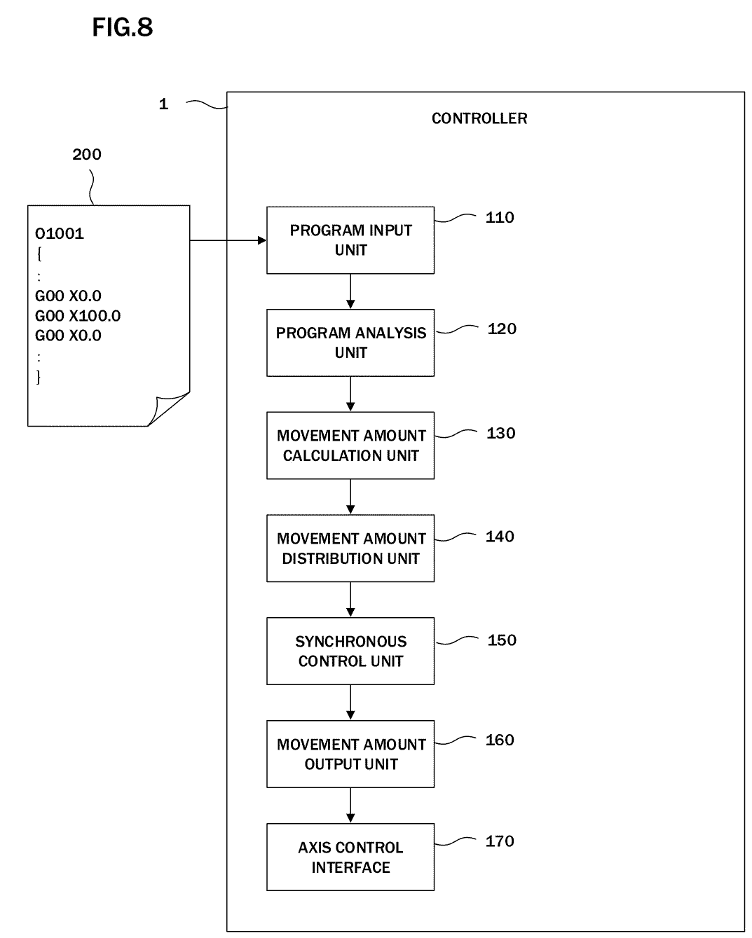

FIG. 9 is a diagram illustrating an industrial machine that moves a machining table on two axes;

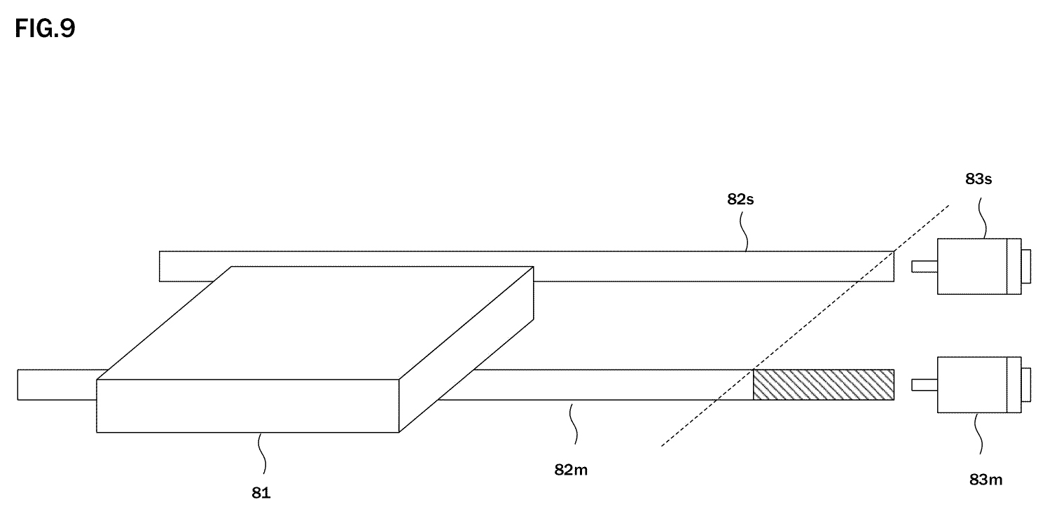

FIG. 10 is a diagram illustrating an industrial machine that rotates a plurality of axes (rollers);

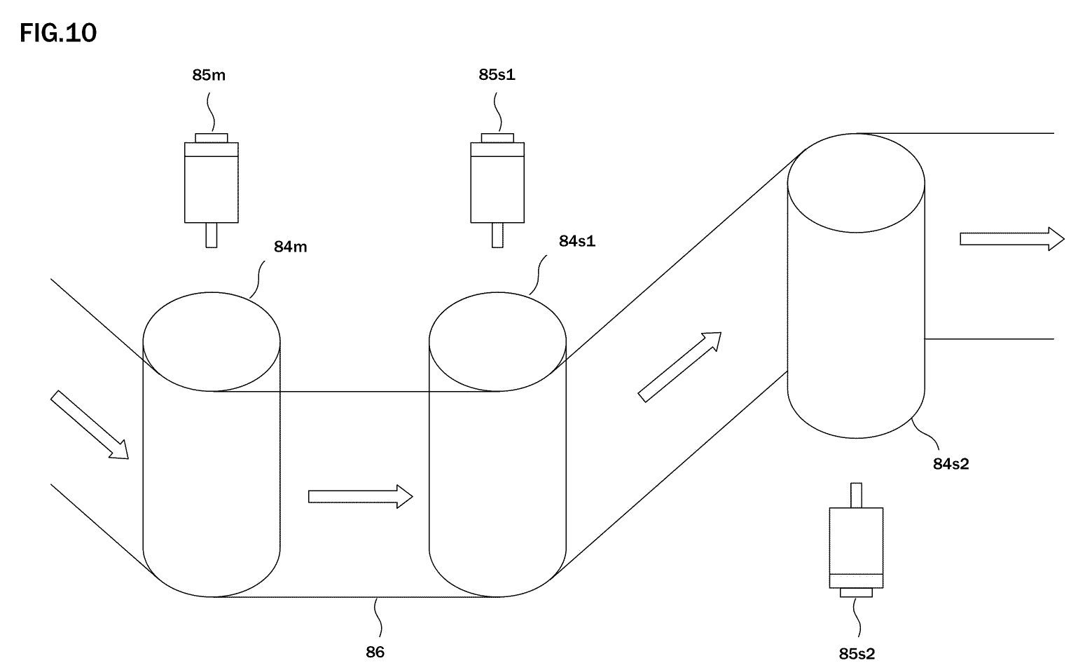

FIG. 11 is a diagram illustrating an industrial machine that moves an object by moving a driving unit up and down with a time lag; and

FIG. 12 is a diagram for describing the case where synchronous control is performed by shifting an operation timing of each system according to a related art.

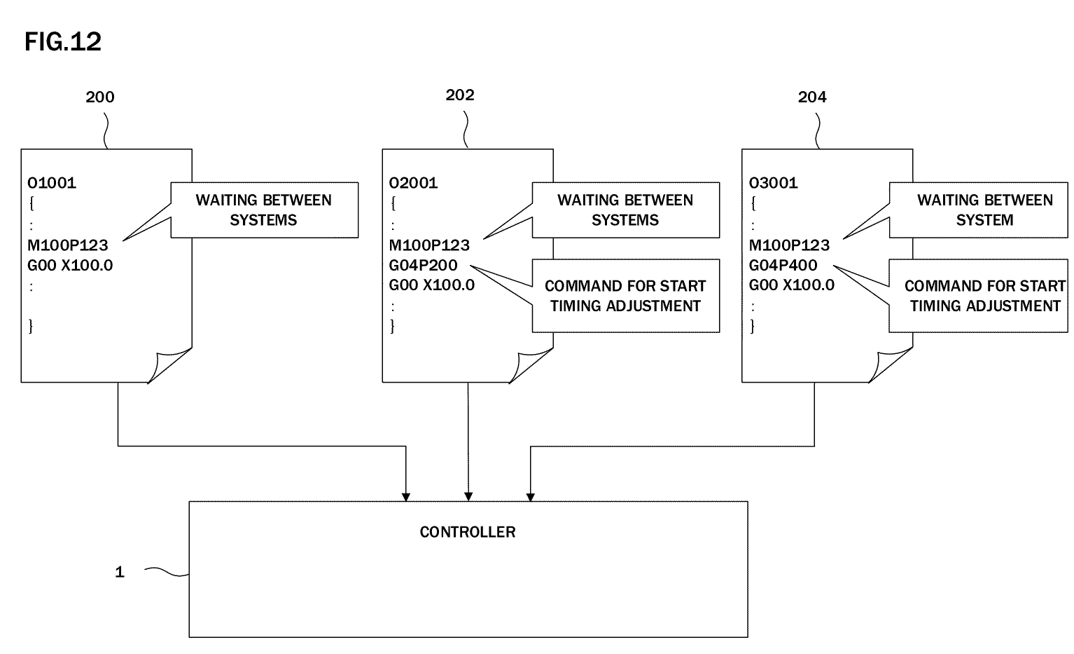

### DESCRIPTION OF EMBODIMENTS

Embodiments of the invention will now be described with reference to the drawings.

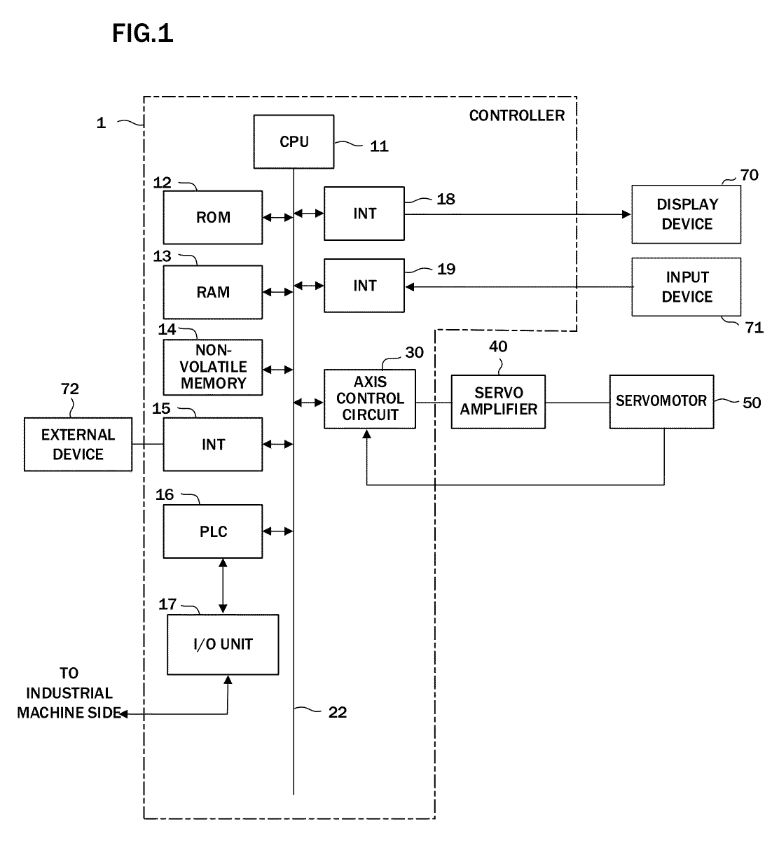

FIG. 1 is a schematic hardware configuration diagram illustrating a main part of a controller according to a first embodiment of the invention. A CPU 11 included in a controller 1 of the invention is a processor that controls the controller 1 as a whole. The CPU 11 reads a system program stored in a ROM 12 via a bus 22 and controls the entire controller 1 according to the system program. Temporary calculation data, display data, various data input from the outside, etc. are temporarily stored in a RAM 13.

A non-volatile memory 14 includes, for example, a memory backed up by a battery (not shown in the figure), an SSD (Solid State Drive), etc., and maintains a storage state even when a power supply of the controller 1 is turned off. The non-volatile memory 14 stores data and control programs read from an external device 72 via an interface 15, data and control programs input via an input device 71, data acquired from an industrial machine, etc. The data and the control programs stored in the non-volatile memory 14 may be loaded in the RAM 13 during execution/use. Further, various system programs such as known analysis programs are written to the ROM 12 in advance.

The interface 15 is that for connecting the CPU 11 of the controller 1 to the external device 72 such as a USB device. From the external device 72 side, for example, it is possible to read a control program, each parameter, etc. used for controlling an industrial machine. Further, a control program, each parameter, etc. edited in the controller 1 may be stored in an external storage means via the external device 72. A programmable logic controller (PLC) 16 is a sequence program built in the controller 1, which outputs a signal to an industrial machine and peripheral devices of the industrial machine (for example, a tool changer, an actuator such as a robot, a sensor attached to the industrial machine, etc.) via an I/O unit 17 to control the industrial machine and peripheral devices. Further, the PLC 16 receives signals of various switches on an operation panel installed in a main body of the industrial machine, the peripheral devices, etc., performs signal processing necessary for the signals, and then passes the signals to the CPU 11.

Each piece of data read on the memory, data obtained as a result of executing a control program or a system program, etc. are output to and displayed on a display device 70 via an interface 18. Further, the input device 71 including a keyboard, a pointing device, etc. passes commands, data, etc. based on operations by an operator to the CPU 11 via an interface 19.

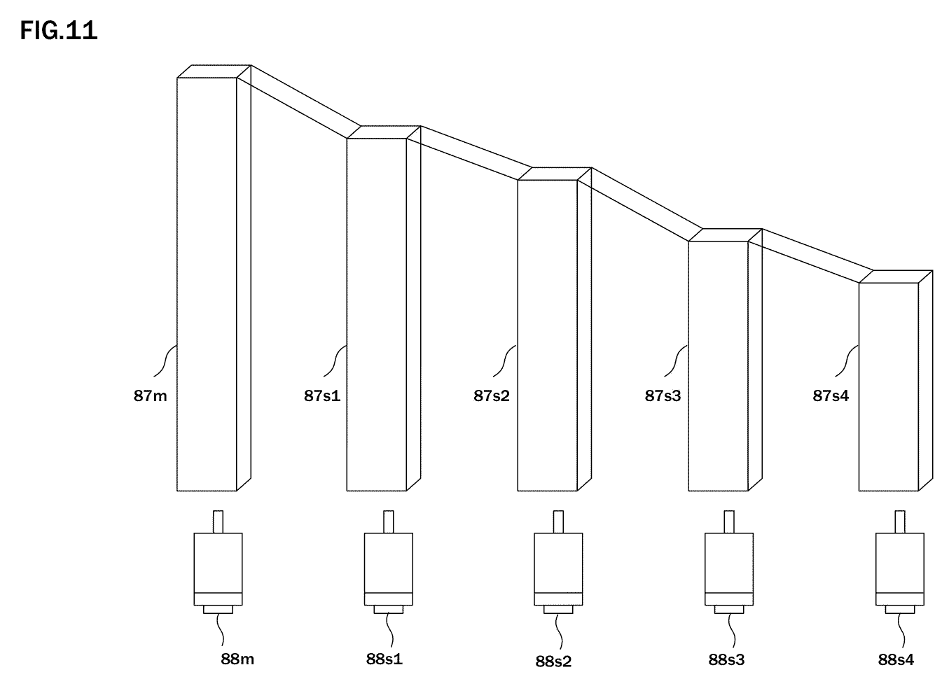

An axis control circuit 30 for controlling an axis included in the industrial machine receives a movement command amount for an axis from the CPU 11 and outputs a command related to the axis to a servo amplifier 40. Upon receiving this command, the servo amplifier 40 drives a servomotor 50 to move a moving object along a predetermined axis of the industrial machine. The servomotor 50 for the axis has a built-in position/speed detector, feeds back a position/speed feedback signal from the position/speed detector to the axis control circuit 30, and performs position/speed feedback control. Note that in the hardware configuration diagram of FIG. 1, only one axis control circuit 30, only one servo amplifier 40, and only one servomotor 50 are illustrated. However, in practice, axis control circuits 30, servo amplifiers 40, and servomotors 50 are prepared so that each of the number of axis control circuits 30, the number of servo amplifiers 40, and the number of servomotors 50 equals the number of axes provided in the industrial machine to be controlled. For example, in the case of controlling a five-axis industrial machine illustrated in FIG. 11, five sets of axis control circuits 30, servo amplifiers 40, and servomotors 50, which drive a master axis and slave axes #1 to #4, respectively, are prepared.

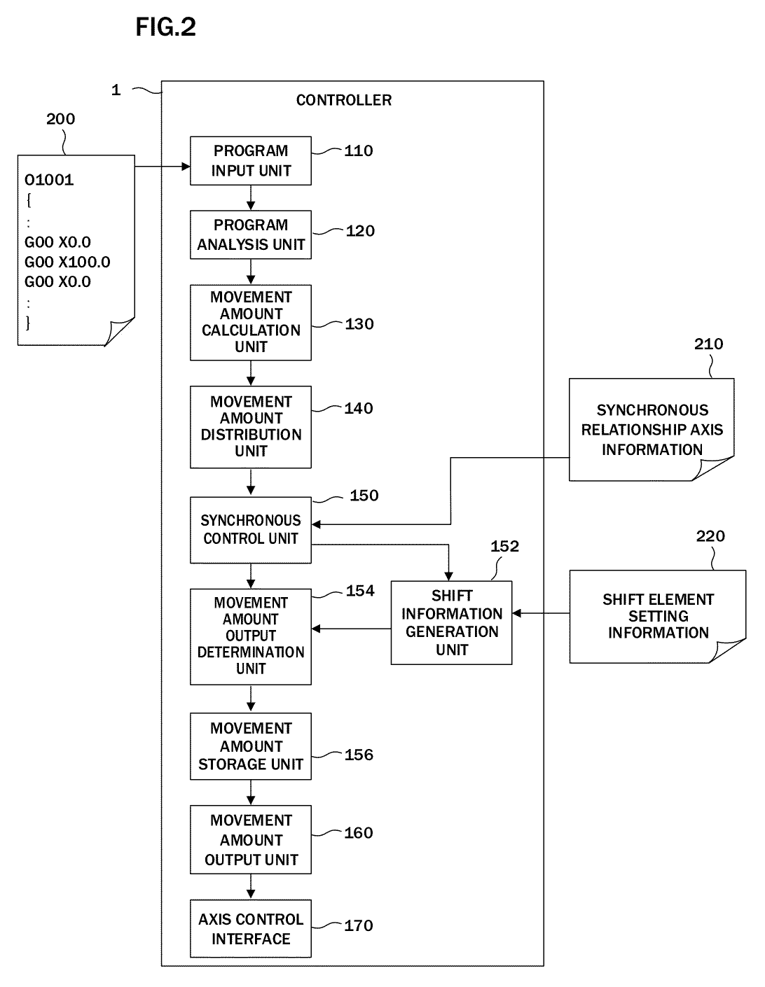

FIG. 2 illustrates functions provided by the controller according to the first embodiment of the invention as a schematic block diagram. Each function provided by the controller 1 according to the present embodiment is implemented by the CPU 11 included in the controller illustrated in FIG. 1 executing a system program and controlling an operation of each unit of the controller 1.

The controller 1 of the present embodiment includes a program input unit 110, a program analysis unit 120, a movement amount calculation unit 130, a movement amount distribution unit 140, a synchronous control unit 150, a shift information generation unit 152, a movement amount output determination unit 154, a movement amount storage unit 156, a movement amount output unit 160, and an axis control interface 170. Further, the RAM 13 or the non-volatile memory 14 of the controller 1 are provided with an area for storing a control program 200 for controlling the operation of the industrial machine. Furthermore, synchronous relationship axis information 210, in which a synchronous relationship between respective axes is set in advance, and shift element setting information 220, in which the shift amount between respective axes is set, are set and stored in a set area provided on the RAM 13 or the non-volatile memory 14 of the controller 1.

The program input unit 110 is implemented by the CPU 11 included in the controller 1 illustrated in FIG. 1 executing a system program read from the ROM 12, and by mainly performing arithmetic processing using the RAM 13 and the non-volatile memory 14 by the CPU 11, and input processing using the interfaces 15 and 19. The program input unit 110 inputs the control program 200 from the input device 71, the external device 72, or a network (not illustrated), and stores the control program 200 in the RAM 13 or the non-volatile memory 14. The control program 200 is mainly used for controlling the master axis of the industrial machine. For example, the control program 200 input by the program input unit 110 may be any program used for controlling the operation of the industrial machine, such as a numerical control program, table format data, or a teaching program.

The program analysis unit 120 is implemented by the CPU 11 included in the controller 1 illustrated in FIG. 1 executing a system program read from the ROM 12, and by mainly performing arithmetic processing using the RAM 13 and the non-volatile memory 14 by the CPU 11. The program analysis unit 120 sequentially reads and analyzes blocks of the control program 200 input by the program input unit 110, and creates command data for controlling each unit of the industrial machine. For example, when a command of the control program 200 is a feed command that commands movement of the axis, the program analysis unit 120 creates data related to a movement path of the axis based on the feed command, a parameter related to operation of the industrial machine, etc. On the other hand, when a command of the control program 200 is a control command related to peripheral devices of the industrial machine, the program analysis unit 120 creates control data of the peripheral devices based on the control command. Since processing related to creation of command data by the program analysis unit 120 belongs to known technology, detailed description here will be omitted. The program analysis unit 120 outputs data related to the created movement path to the movement amount calculation unit 130. In addition, data related to other controls is output to each functional unit (not shown in the figures) that uses the control data.

The movement amount calculation unit 130 is implemented by the CPU 11 included in the controller 1 illustrated in FIG. 1 executing a system program read from the ROM 12, and by mainly performing arithmetic processing using the RAM 13 and the non-volatile memory 14 by the CPU 11. The movement amount calculation unit 130 calculates the movement amount of a predetermined axis on the basis of the movement path based on data related to the movement path created by the program analysis unit 120. For example, when the data related to the movement path is that of the master axis, the movement amount calculation unit 130 calculates the movement amount required to move the master axis along the movement path. The movement amount calculated by the movement amount calculation unit 130 is output to the movement amount distribution unit 140.

The movement amount distribution unit 140 is implemented by the CPU 11 included in the controller 1 illustrated in FIG. 1 executing a system program read from the ROM 12, and by mainly performing arithmetic processing using the RAM 13 and the non-volatile memory 14 by the CPU 11. The movement amount distribution unit 140 creates the distribution movement amount (distribution data) obtained by distributing the movement amount calculated by the movement amount calculation unit 130 as the movement amount of the axis for each distribution cycle. The movement amount distribution unit 140 distributes the movement amount to each distribution cycle so that movement is performed within a range not exceeding a maximum movement speed set for the axis. Further, at this time, the movement amount is distributed to each distribution cycle so that acceleration/deceleration is performed in a range not exceeding the maximum acceleration set for the axis. The movement amount distribution unit 140 outputs the created distribution movement amount to the synchronous control unit.

The synchronous control unit 150 is implemented by the CPU 11 included in the controller 1 illustrated in FIG. 1 executing a system program read from the ROM 12, and by mainly performing arithmetic processing using the RAM 13 and the non-volatile memory 14 by the CPU 11. The synchronous control unit 150 creates the distribution movement amount of the slave axis synchronized with the master axis based on the distribution movement amount created by the movement amount distribution unit 140. In the set area provided in the RAM 13 or the non-volatile memory 14 of the controller 1, the synchronous relationship axis information 210 in which the synchronous relationship between the respective axes is defined in advance is set. The synchronous control unit 150 refers to the synchronous relationship axis information 210, and creates (reproduces), for a slave axis in synchronization with the master axis, the distribution movement amount of the slave axis based on the distribution movement amount of the master axis created by the movement amount distribution unit 140. For example, as illustrated in FIG. 11, when four axes (slave axes #1 to #4) are set to synchronize with one master axis, the synchronous control unit 150 creates the same distribution movement amount as the distribution movement amount of the master axis for the slave axes #1 to #4. The synchronous relationship axis information 210 may further define a synchronization ratio between the master axis and the slave axis. In this case, the synchronous control unit 150 creates the distribution movement amount in consideration of the synchronization ratio for the slave axis synchronized with the master axis. For example, when the slave axis synchronizes with the master axis at a synchronization ratio of 2 (slave) : 1 (master), the synchronous control unit 150 doubles the distribution movement amount of the master axis for each distribution cycle and creates the distribution movement amount of the slave axis. The synchronous control unit 150 outputs information related to the synchronous relationship between the master axis and the slave axis to the shift information generation unit 152. Further, the synchronous control unit 150 outputs the distribution movement amount of the master axis and the distribution movement amount of the slave axis to the movement amount output determination unit 154.

The shift information generation unit 152 is implemented by the CPU 11 included in the controller 1 illustrated in FIG. 1 executing a system program read from the ROM 12, and by mainly performing arithmetic processing using the RAM 13 and the non-volatile memory 14 by the CPU 11. The shift information generation unit 152 generates shift information indicating the shift amount of the operation of each axis based on information related to the synchronous relationship between the axes input from the synchronous control unit 150 and the shift element setting information 220 set in the RAM 13 or the non-volatile memory 14 of the controller 1. The shift element setting information 220 according to the present embodiment sets a shift element with respect to a shift reference axis for each axis. For the slave axis, the master axis becomes the shift reference axis. In addition, for the master axis, the master axis becomes the shift reference axis. The shift element indicating the reference amount serving as a basis for a shift may be set in units of time. Further, the shift element may be set according to the movement amount of a predetermined axis or another basis. Processing in the shift information generation unit 152 may be performed only once for each execution unit of the control program 200 in which the movement amount is generated since it is sufficient that shift information is generated at the start of operation of the synchronous relationship axis. The shift information generation unit 152 outputs the generated shift information to the movement amount output determination unit 154.

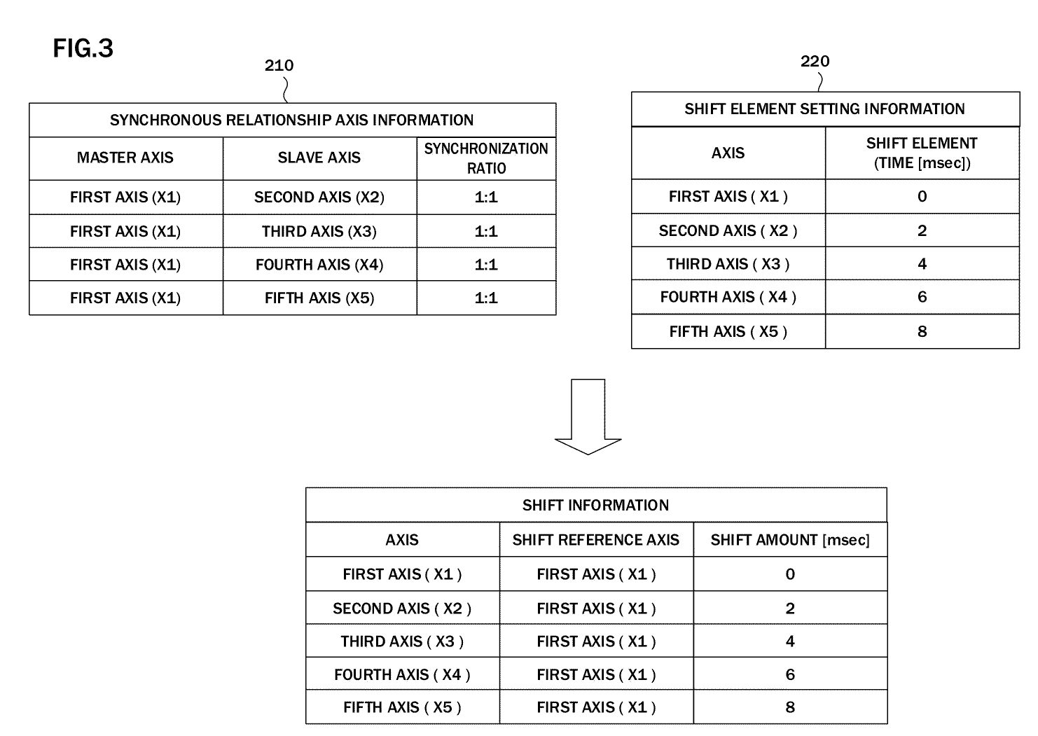

FIG. 3 illustrates an example of shift information generated by the shift information generation unit 152.

In the example of FIG. 3, in the synchronous relationship axis information 210, a first axis (X1-axis) is the master axis, and a second axis (X2-axis), a third axis (X3-axis), a fourth axis (X4-axis), and a fifth axis (X5-axis) are set as slave axes in synchronization with the master axis. Further, in the shift element setting information 220, the shift element is time, a shift reference axis of the first axis is set to itself (shift amount 0 msec), and the shift amounts of the second axis, the third axis, the fourth axis, and the fifth axis are set to 2 msec, 4 msec, 6 msec, and 8 msec, respectively, with respect to the master axis (first axis), which is the shift reference axis. When each piece of information is set in this way, the shift information generation unit 152 generates shift information for setting the shift amounts using, as shift elements, times of 0 msec with respect to the first axis for the first axis, 2 msec with respect to the first axis for the second axis, 4 msec with respect to the first axis for the third axis, 6 msec with respect to the first axis for the fourth axis, and 8 msec with respect to the first axis for the fifth axis.

Note that the example of FIG. 3 illustrates a simple example in which the first axis is set as the master axis, and all the other axes are set as slave axes with respect to the first axis. However, it should be noted that it is possible to set a plurality of combinations of master axes and slave axes that are not related to each other in one industrial machine. In addition, it should be noted that a slave axis with respect to one master axis may also be a master axis with respect to another slave axis.

The movement amount output determination unit 154 is implemented by the CPU 11 included in the controller 1 illustrated in FIG. 1 executing a system program read from the ROM 12, and by mainly performing arithmetic processing using the RAM 13 and the non-volatile memory 14 by the CPU 11. The movement amount output determination unit 154 determines an output timing of the movement amount of each axis. Upon receiving shift information from the shift information generation unit 152, the movement amount output determination unit 154 monitors progress or change of the reference amount since an axis control operation is started. Then, the movement amount output determination unit 154 commands the movement amount storage unit 156 to store the distribution movement amount of the axis, for which a time point when output needs to be performed is not reached, for each distribution cycle. Further, the movement amount output determination unit 154 determines that the movement amount of the axis needs to be output when the reference amount has progressed by the shift amount designated for each axis, and commands the movement amount storage unit 156 to sequentially output the distribution movement amount of the axis for each distribution cycle.

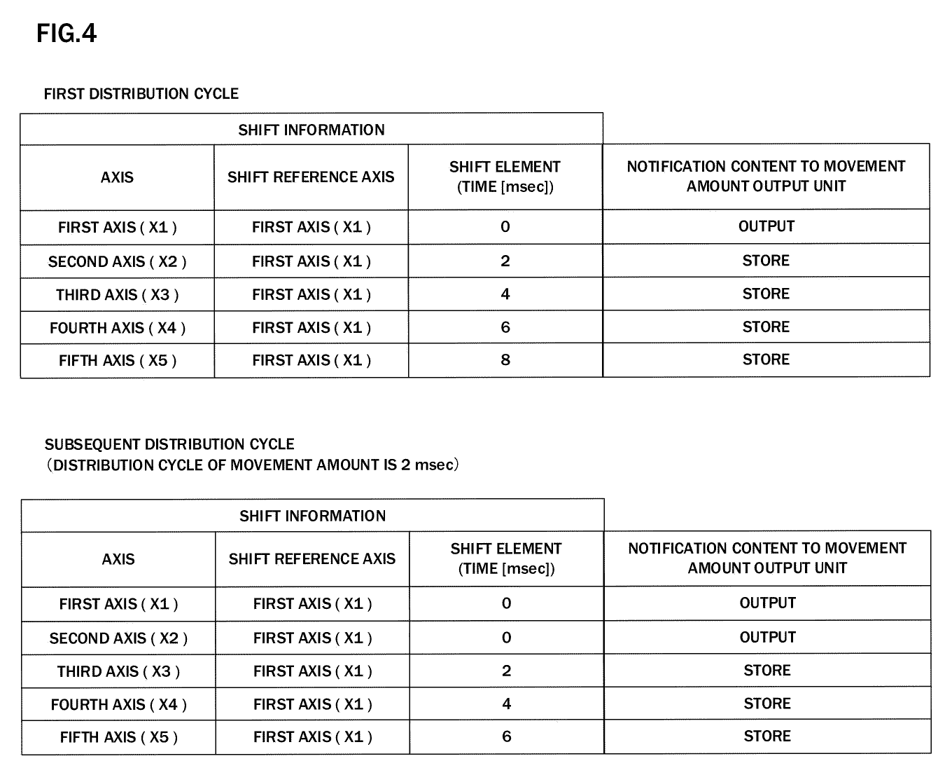

FIG. 4 is a diagram for describing an operation of the movement amount output determination unit 154.

In an example of FIG. 4, it is assumed that the movement amount output determination unit 154 performs output determination for the movement amounts of the first axis to the fifth axis based on the shift information illustrated in FIG. 3. It is assumed that the reference amount (shift amount) indicating a basis for a shift is set on a time basis, and the distribution cycle of the movement amount of the controller 1 is 2 msec. At this time, in a first cycle in which the axis control operation is started in the controller 1 (the progressing reference amount is 0 msec), the movement amount output determination unit 154 commands the movement amount storage unit 156 to sequentially output the distribution movement amount for each distribution cycle for the first axis, the shift amount of which is set to 0 msec, and commands the movement amount storage unit 156 to store the distribution movement amount for each distribution cycle for the second axis to the fifth axis, the shift amounts of which are set to 0 msec or more.

Next, at the beginning of the distribution cycle, the movement amount output determination unit 154 decreases the shift amount of each axis included in the shift information by the amount of the distribution cycle (however, the shift amount ≥ 0) in order to record the progress of the reference amount. Then, the movement amount output determination unit 154 commands the movement amount storage unit 156 to sequentially output the distribution movement amount for each distribution cycle for the first axis, the shift amount of which is set to 0 msec, and the second axis, the shift amount of which is decreased to become 0 msec, and commands the movement amount storage unit 156 to store the distribution movement amount for each distribution cycle for the third axis to the fifth axis, the shift amount of which is set to 0 msec or more.

By repeating such an operation, the movement amount output determination unit 154 monitors whether or not the reference amount has progressed or changed by the shift amount for each axis, determines output of the distribution movement amount of each axis based on the monitoring result, and commands the movement amount storage unit 156. Note that even though progress or change of the reference amount is monitored by decreasing the shift amount included in the shift information in the above example, the movement amount output determination unit 154 may separately store progress or change of the reference amount, and monitor whether or not the reference amount has progressed or changed by the shift amount by comparing the progressing or changing reference amount with the shift amount.

The movement amount storage unit 156 is implemented by the CPU 11 included in the controller 1 illustrated in FIG. 1 executing a system program read from the ROM 12, and by mainly performing arithmetic processing using the RAM 13 and the non-volatile memory 14 by the CPU 11. The movement amount storage unit 156 stores, in a buffer, the distribution movement amount of the axis reported from the movement amount output determination unit 154. Further, in the case of being commanded from the movement amount output determination unit 154 to output the distribution movement amount of the axis, the movement amount storage unit 156 sequentially outputs the stored distribution movement amount to the movement amount output unit 160. The movement amount storage unit 156 functions as a FIFO (First In First Out) buffer in storage and output of the distribution movement amount.

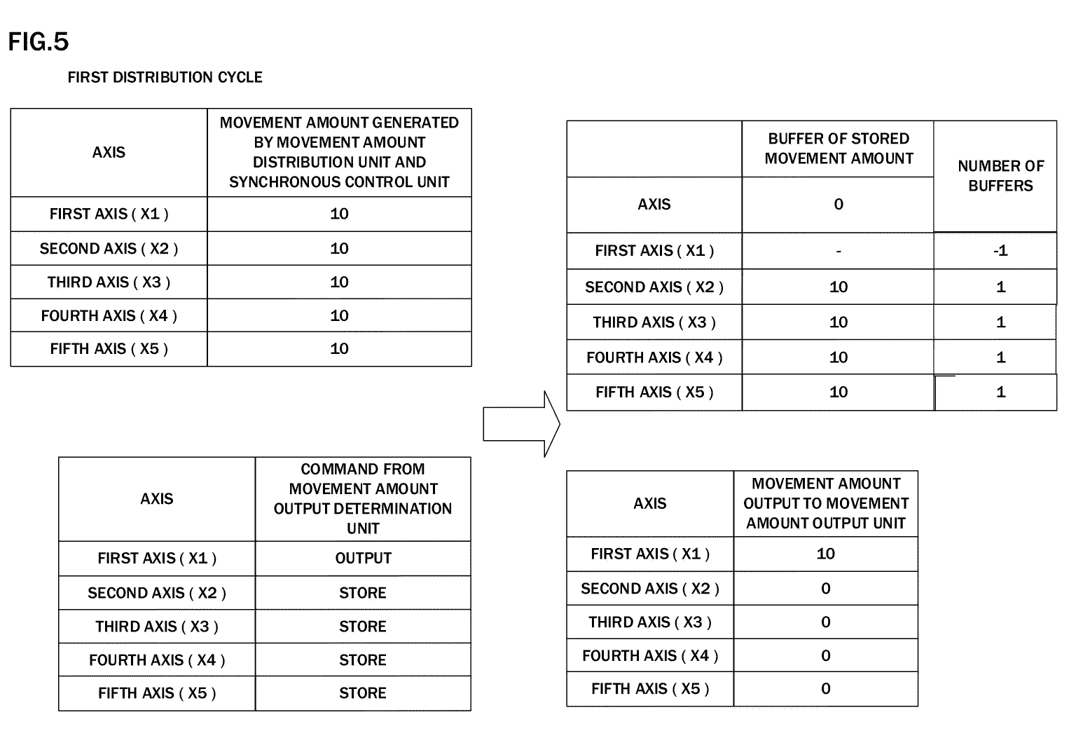

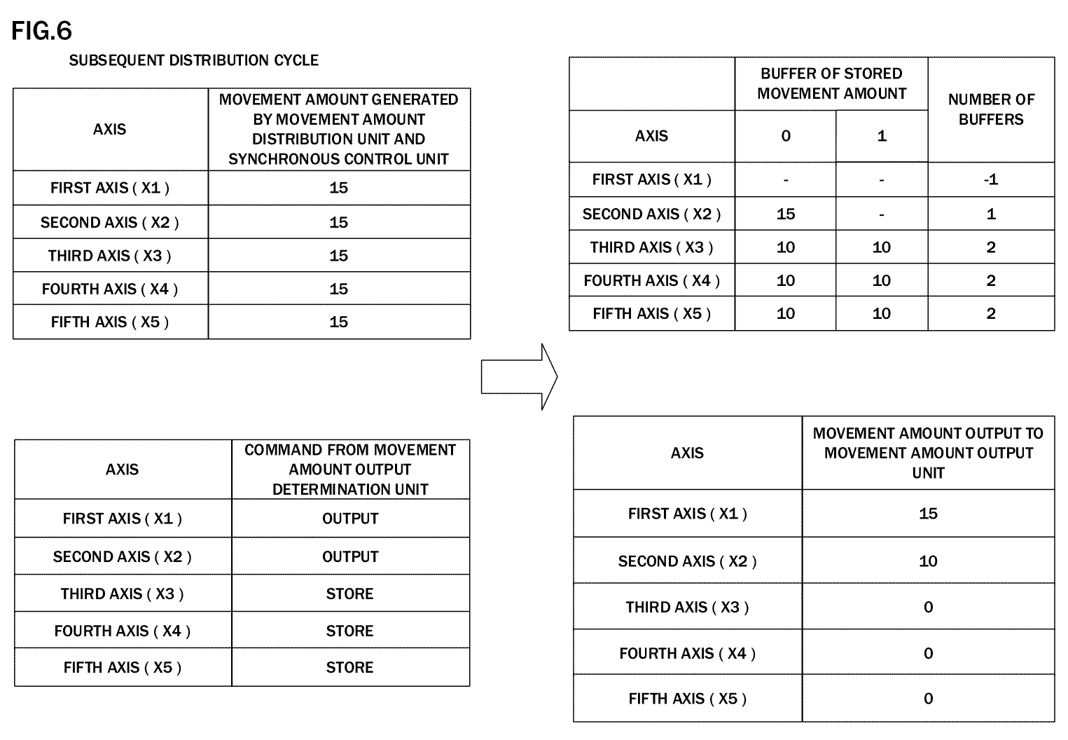

FIGS. 5 and 6 are diagrams for describing an operation of the movement amount storage unit 156.

In an example of FIGS. 5 and 6, it is assumed that the movement amount output determination unit 154 performs output determination for the movement amounts of the first axis to the fifth axis based on the shift information illustrated in FIG. 3. At this time, at the first distribution cycle (the progressing reference amount is 0 msec) when the axis control operation is started in the controller 1, the movement amount distribution unit 140 and the synchronous control unit 150 generate the distribution movement amount (10) for each of the first axis to the fifth axis as illustrated in FIG. 5. Further, in the first distribution cycle, the movement amount output determination unit 154 outputs the distribution movement amount of the first axis, and commands the movement amount storage unit 156 so as to store the distribution movement amounts of the second axis to the fifth axis. As a result, the movement amount storage unit 156 outputs the distribution movement amount of the first axis without storing the distribution movement amount (number of buffers = -1), and stores the distribution movement amounts of the second axis to fifth axis in the buffer (number of buffers = 1 each). As a result, in the first distribution cycle, the movement amount storage unit 156 outputs the distribution movement amount (10) of the first axis to the movement amount output unit 160.

Then, in a subsequent distribution cycle, the movement amount distribution unit 140 and the synchronous control unit 150 generate the distribution movement amount (15) for each of the first axis to the fifth axis. Further, in this distribution cycle, the movement amount output determination unit 154 outputs the distribution movement amounts of the first axis and the second axis, and commands the movement amount storage unit 156 to store the distribution movement amounts of the third axis to the fifth axis. As a result, the movement amount storage unit 156 outputs the distribution movement amount of the first axis without storing the distribution movement amount (number of buffers = -1), and outputs the distribution movement amount corresponding to one distribution cycle stored in the buffer and stores the subsequent distribution movement amount (number of buffers = 1) for the distribution movement amount of the second axis. Then, the distribution movement amounts of the third axis to the fifth axis are additionally stored in the buffer (number of buffers = 2 each). As a result, in the subsequent distribution cycle, the movement amount storage unit 156 outputs the distribution movement amount (15) of the first axis and the distribution movement amount (10) of the second axis to the movement amount output unit 160.

By repeating such an operation, the movement amount storage unit 156 outputs the distribution movement amount to the movement amount output unit 160 for each axis at a timing determined by the movement amount output determination unit 154, that is, at a timing of shifting by the shift amount set with respect to the shift reference axis.

The movement amount output unit 160 is implemented by the CPU 11 included in the controller 1 illustrated in FIG. 1 executing a system program read from the ROM 12, and by mainly performing arithmetic processing using the RAM 13 and the non-volatile memory 14 and control processing using the axis control circuit 30 by the CPU 11. The movement amount output unit 160 outputs the distribution movement amount of the axis output from the movement amount storage unit 156 to the axis control interface 170.

The axis control interface 170 is implemented by the CPU 11 included in the controller 1 illustrated in FIG. 1 executing a system program read from the ROM 12, and by mainly performing arithmetic processing using the RAM 13 and the non-volatile memory 14 and control processing using the axis control circuit 30 and the servo amplifier 40 by the CPU 11. The axis control interface 170 outputs the distribution movement amount output from the movement amount output unit 160 to the servomotor 50 that drives each axis.

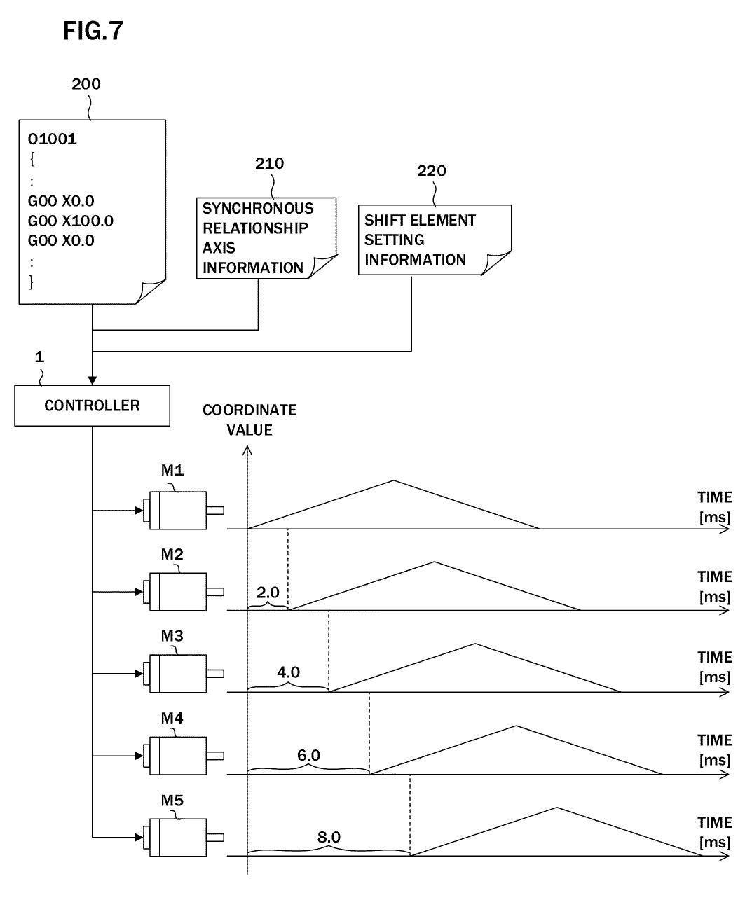

As illustrated in FIG. 7, the controller 1 according to the present embodiment having the above configuration may designate an operation start timing of the synchronous relationship axis by one simple control program 200 and the shift element setting information 220. As a result, it is unnecessary to create a control program for each axis, and thus the burden on the operator may be reduced. Further, since it is unnecessary to hold and process a plurality of operation programs in the controller 1, efficient control with less resources may be achieved. Note that in FIG. 7, reference symbols M1 to M5 denote servomotors of the first axis to the fifth axis.

Even though the embodiments of the invention have been described above, the invention is not limited to the only examples of the above-described embodiments, and may be implemented in various embodiments by making appropriate changes.

In the embodiments, an example, in which the shift element indicating the reference amount serving as a basis for a shift is set in units of time, has been illustrated. However, when the shift element is set in units of the movement amount of a predetermined axis, the movement amount output determination unit 154 may monitor the distribution movement amount output for an axis to be monitored, and when the axis to be monitored moves by the shift amount set for a slave axis, the movement amount output determination unit 154 may start output of the distribution movement amount of the slave axis.

EXPLANATIONS OF LETTERS OR NUMERALS

| | |
|---|---|
| 1 | CONTROLLER |
| 11 | CPU |
| 12 | ROM |
| 13 | RAM |
| 14 | NON-VOLATILE MEMORY |
| 15, 18, 19 | INTERFACE |
| 16 | PLC |
| 17 | I/O UNIT |
| 22 | BUS |
| 30 | AXIS CONTROL CIRCUIT |
| 40 | SERVO AMPLIFIER |
| 50 | SERVOMOTOR |
| 70 | DISPLAY DEVICE |
| 71 | INPUT DEVICE |
| 72 | EXTERNAL DEVICE |
| 110 | PROGRAM INPUT UNIT |
| 120 | PROGRAM ANALYSIS UNIT |
| 130 | MOVEMENT AMOUNT CALCULATION UNIT |
| 140 | MOVEMENT AMOUNT DISTRIBUTION UNIT |
| 150 | SYNCHRONOUS CONTROL UNIT |
| 152 | SHIFT INFORMATION GENERATION UNIT |
| 154 | MOVEMENT AMOUNT OUTPUT DETERMINATION UNIT |
| 156 | MOVEMENT AMOUNT STORAGE UNIT |
| 160 | MOVEMENT AMOUNT OUTPUT UNIT |
| 170 | AXIS CONTROL INTERFACE |
| 200, 202, 204 | CONTROL PROGRAM |
| 210 | SYNCHRONOUS RELATIONSHIP AXIS INFORMATION |
| 220 | SHIFT ELEMENT SETTING INFORMATION |

1. A controller for controlling axes in a synchronous relationship based on a control program for controlling an operation of one shift reference axis among axes in the synchronous relationship, the controller comprising:
a shift information generation unit configured to generate shift information including a shift element indicating an operation timing of another axis with respect to the shift reference axis;
a movement amount output determination unit configured to determine a timing of outputting a movement amount related to each of the plurality of axes according to the shift information; and
a movement amount storage unit configured to output a movement amount of an axis when the movement amount output determination unit determines that it is a timing to output the movement amount, and to buffer a movement amount of an axis when the movement amount output determination unit determines that it is not a timing to output the movement amount.

2. The controller according to claim 1, wherein the shift element is set on a time basis.

3. The controller according to claim 1, wherein the shift element is set on a basis of a movement amount of one axis among a plurality of axes.
